(19) United States
(12) Patent Application Publication
(10) Pub. No.: US 2008/0206615 A1
(43) Pub. Date: Aug. 28, 2008

(54) GAS DIFFUSION LAYER WITH CONTROLLED DIFFUSIVITY OVER ACTIVE AREA

(76) Inventors: Paul Nicotera, Honeoye Falls, NY (US); Mark Mathias, Pittsford, NY (US); Chunxin Ji, Pennfield, NY (US); Steven G. Goebel, Victor, NY (US)

Correspondence Address: FRASER CLEMENS MARTIN & MILLER LLC, 28366 KENSINGTON LANE, PERRYSBURG, OH, 43551-4163, US

(21) Appl. No.: 11/677,873

(22) Filed: Feb. 22, 2007

(51) Int. Cl. H01M 8/10; B05D 3/02

(52) U.S. Cl. 429/30; 427/372.2

(57) ABSTRACT

A diffusion medium for use in a PEM fuel cell comprising a thin perforated layer having variable size and frequency of perforation patterns incorporated into a microporous layer on a first side of a porous substrate layer, wherein the diffusion medium is adapted to improve water management and performance of the fuel cell.

### FIELD OF THE INVENTION

The invention relates to a fuel cell and more particularly to a diffusion medium, and a method of preparing the same, adapted to improve water management within the fuel cell, the diffusion medium including a porous substrate layer, a thin perforated layer having variable size and frequency of perforation patterns, and at least a microporous layer, wherein the microporous layer and thin perforated layer are applied on the porous substrate layer.

### BACKGROUND OF THE INVENTION

Fuel cells are increasingly being used as power source for electric vehicles and other applications. In proton exchange membrane (PEM) fuel cells, hydrogen gas is supplied to an anode side of the fuel cell and oxygen gas is supplied as an oxidant to a cathode side of the fuel cell. The reaction that occurs between the reactant gases in the fuel cell consumes the hydrogen at the anode side and produces product water at the cathode side. PEM fuel cells include a membrane electrode assembly (MEA) comprising a thin, proton transmissive non-electrically conductive solid polymer electrolyte membrane disposed with the anode side on one face and the cathode side on an opposite face.

Gas diffusion media play an important role in PEM fuel cells. Generally disposed between catalytic electrodes and the flow field channels of the bipolar plates in the fuel cell, gas diffusion media provide reactant and product permeability, electronic conductivity, and thermal conductivity, as well as mechanical strength needed for proper functioning of the fuel cell. Efficient operation of the fuel cell depends on the ability to provide effective water management in the system. The diffusion media prevent the electrodes from filling with water and restricting the flow of oxygen (known as flooding) by removing the product water away from the catalytic electrodes while maintaining reactant gas flow from the gas flow channels of the bipolar plates to the catalytic electrodes.

Typically, diffusion media used in PEM fuel cells have relatively constant diffusion resistance over an entire area of the media because the structure and size of the pores in the diffusion media are uniform. The performance of automotive fuel cells using current diffusion media is limited because reactant streams are often subsaturated, and there is a large variation of humidity and current (i.e. water production) over the active area of the cell. Thus, the rate of product water removal in wet operating regions must be balanced with the need to maintain a certain degree of membrane hydration in dry operating regions to obtain satisfactory proton conductivity in the fuel cell.

Accordingly, the present invention is a diffusion medium adapted to provide varying local water management capability to enable the highest fuel cell performance. In the diffusion medium described herein, improved operation in the dry regions is achieved by restricting a water vapor flow rate away from the membrane in the dry regions of the active area to maintain acceptable membrane proton conductivity while also maintaining an acceptable flow of reactant gases, and in the wet regions of the fuel cell less restriction is applied so as not to decrease the performance of the fuel cell due to excessive water retention and reactant gas blockage.

### SUMMARY OF THE INVENTION

Concordant and congruous with the present invention a diffusion medium adapted to improve water management while also improving the performance of the fuel cell has been discovered.

In another embodiment, a diffusion medium for use in a PEM fuel cell comprising a porous substrate layer having a first side and a second side, wherein said substrate layer is electrically conductive; a thin perforated layer having a plurality of perforations; a first microporous layer, wherein said first microporous layer is disposed between the first side of said porous substrate layer and said thin perforated layer, said first microporous layer incorporated into the first side of said porous substrate layer, and the thin perforated layer is incorporated into said first microporous layer; and a second microporous layer disposed on and incorporated with said thin perforated layer.

In one embodiment, a diffusion medium for use in a PEM fuel cell comprising a porous substrate layer having a first side and a second side, wherein said porous substrate layer is electrically conductive; a first microporous layer; and a thin perforated layer having a plurality of perforations, a first side, and a second side, wherein said first microporous layer is disposed between and incorporated into the first side of said porous substrate layer and the first side of said thin perforated layer.

In another embodiment, a method for making a diffusion medium for use in a PEM fuel cell, comprising the steps of providing a porous substrate layer, wherein said porous substrate layer is electrically conductive; providing a thin perforated layer with one of a variable size and frequency of perforation pattern; treating the porous substrate layer with a fluoropolymer; coating the flouropolymer treated porous substrate layer with a paste to form a microporous layer; compressing the thin perforated layer onto the wet microporous layer; drying the microporous layer and the porous substrate layer; and sintering the porous substrate layer, thin perforated layer, and the microporous layer together.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a cross-sectional view of a gas diffusion medium according to an embodiment of the invention;

FIG. 2 is a cross-sectional view of a gas diffusion medium according to another embodiment of the invention;

FIG. 3 is a cross-sectional view of a gas diffusion medium according to another embodiment of the invention;

FIG. 4 is an exploded view of a fuel cell stack, showing two fuel cells, including the gas diffusion medium shown in FIG. 1;

FIG. 5 is a cross-sectional view of a single PEM fuel cell including the gas diffusion medium shown in FIG. 1;

FIG. 6 is a table showing a total diffusion resistance of a gas diffusion medium without a thin perforated layer, a gas diffusion medium having a thin perforated layer with a 25% open area, and a gas diffusion medium having a thin perforated layer with a 5% open area;

FIG. 7 is a graph showing current voltage performance of a gas diffusion medium without a thin perforated layer, a gas diffusion medium having a thin perforated layer with a 25% open area, and a gas diffusion medium having a thin perforated layer with a 5% open area in a fuel cell operated at a high relative humidity; and

FIG. 8 is a graph showing current voltage performance of a gas diffusion medium without a thin perforated layer, a gas diffusion medium having a thin perforated layer with a 25% open area, and a gas diffusion medium having a thin perforated layer with a 5% open area in a fuel cell operated at a low relative humidity.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

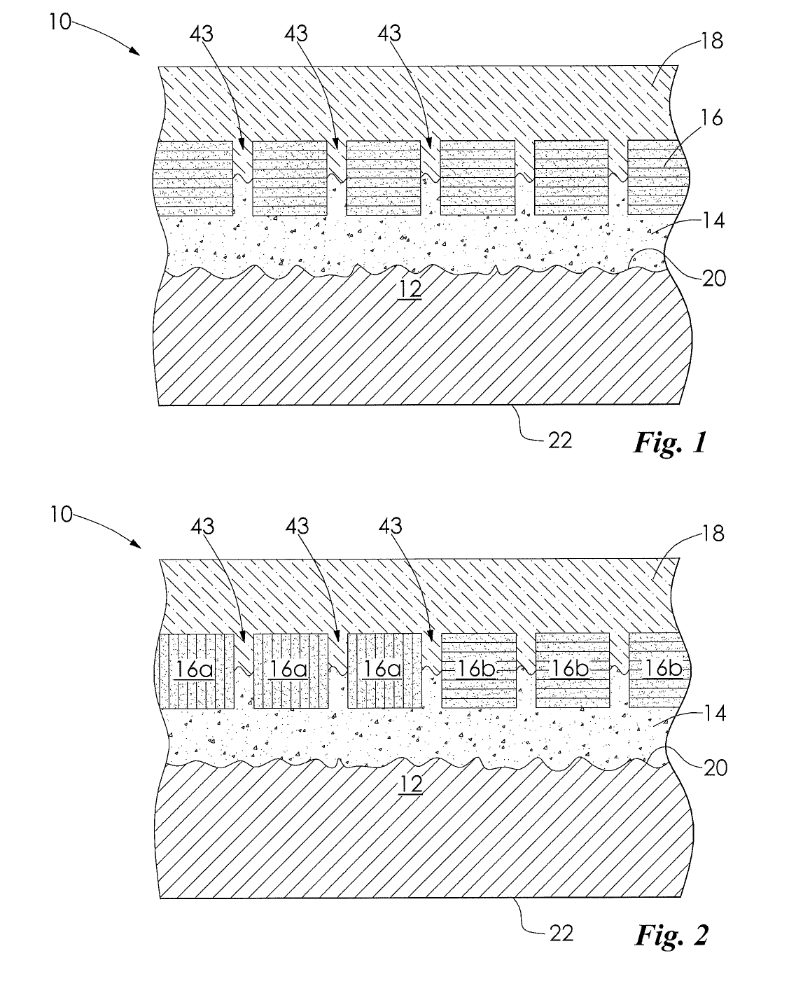

FIG. 1 illustrates a diffusion medium 10 according to an embodiment of the invention. The diffusion medium 10 includes a porous substrate layer 12, a first microporous layer 14, a thin perforated layer 16, and a second microporous layer 18. It is understood that the thickness of the diffusion medium 10 and layers 12, 14, 16, 18 thereof may vary based on a desired performance of a fuel cell in which the diffusion medium 10 is used.

The porous substrate layer 12 is a carbon fiber paper (CFP) having a first side 20 and a second side 22. In the embodiment shown, the porous substrate layer 12 is treated with a fluorocarbon polymer such as polytetrafluoroethylene (PTFE) (not shown). Any traditional CFP such as the MRC U-105 paper produced by Mitsubishi Rayon Company may be used. It is understood that the porous substrate layer 12 may also be a carbon cloth or other conventional material adapted to be electrically and thermally conductive. Furthermore, the porous substrate layer 12 may be untreated or treated with materials other than a fluorocarbon polymer, as desired.

The first microporous layer 14 and the second microporous layer 18 are formed from a carbon powder and fluorocarbon polymer mixture. It is understood that either the first microporous layer 14 or the second microporous layer 18 may not be required and that only one of the first microporous layer 14 or the second microporous layer 18 may be used.

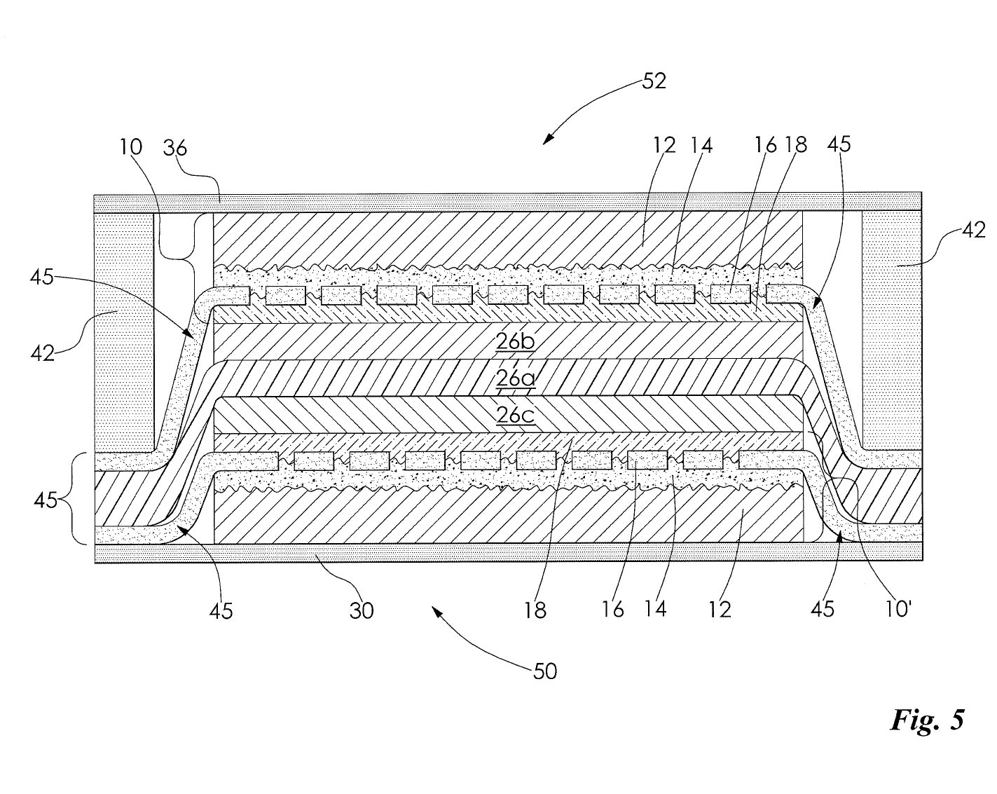

The thin perforated layer 16 has a plurality of selectively distributed perforations 43. The thin perforated layer 16 also has an un-perforated perimeter portion 45, as shown in FIG. 5. It is understood the thin perforated layer 16 may not have an un-perforated perimeter portion 45, as desired. In the embodiment shown, the thin perforated layer 16 is a graphite foil.

However, the thin perforated layer 16 may be formed from other conventional materials such as metal sheets, polymeric materials, composite materials, an impregnated polymeric material, or any conventional non-conductive material, for example. The perforations 43 of the thin perforated layer 16 may vary to produce variations in local properties. For example, the size and frequency of the perforations 43 in the thin perforated layer 16 may be varied to provide a different open area (i.e. pore volume). Reducing the frequency of the perforations 43 in the thin perforated layer 16 results in a higher tortuosity (i.e. effective pore length) of the diffusion medium 10. A uniform piece of graphite foil may be used to form the thin perforated layer 16 or the thin perforated layer 16 may be formed from a plurality of graphite foil sheets 16a, 16b having a different size and frequency of the perforations disposed adjacent one another, as illustrated in FIG. 2.

To form the diffusion medium 10, the porous substrate layer 12 is treated with the PTFE to form a treated porous substrate layer 12. The thin perforated layer 16 having a desired open area and perforation pattern is formed from a sheet of graphite foil (not shown) by rolling the graphite sheet between rollers (not shown) having protuberant elements adapted to produce the perforations 43 in the foil in a desired pattern, shape, and size. A continuous process similar to the one described in U.S. Pat. No. 6,521,369 to Mercuri et al. or a multi-step process may be used to form the thin perforated layer 16, as desired. The size and placement of the protuberant elements will vary based on the desired pattern, shape, and size of the perforations 43 to obtain the desired diffusion resistance through the diffusion medium 10.

Next, a paste (not shown) is formed containing a mixture of the carbon powder and fluorocarbon polymers and applied to the first side 20 of the porous substrate layer 12 to form the first microporous layer 14 such that the first microporous layer 14 permeates into the pores on the first side 20 of the porous substrate layer 12. While the first microporous layer 14 is wet, the thin perforated layer 16 is compressed against the first microporous layer 14 on the first side 20 of the porous substrate layer 12 such that the first microporous layer 14 is pressed into the perforations 43 of the thin perforated layer 16 to incorporate the thin perforated layer 16 with the first microporous layer 14 and the porous substrate layer 12, as shown in FIG. 1. The first microporous layer 14 is then allowed to dry. As used herein, incorporate is understood to mean one layer of the diffusion medium 10 adheres to, penetrates, seeps, or otherwise permeates into the interstitial space of an adjacent layer to promote integration of the layers.

The carbon powder paste is applied to the thin perforated layer 16 to form the second microporous layer 18 such that the second microporous layer 18 permeates into the perforations of the thin perforated layer 16. The treated porous substrate layer 12, the first microporous layer 14, the thin perforated layer 16, and the second microporous layer 18 are then sintered at or near 380° C. to form the diffusion medium 10. The sintering process causes the first microporous layer 14, the thin perforated layer 16, the second microporous layer 18, and the porous substrate layer 12 to adhere together. Commonly owned U.S. Pat. No. 7,063,913 for DIFFUSION MEDIA WITH A MICROPOROUS LAYER is hereby incorporated by reference to further describe methods for preparing the paste and other materials and processes used in preparing the diffusion medium 10. It is understood that if the thin perforated layer 16 is a polymeric material or similar material, the porous substrate layer 12, the first microporous layer 14, the thin perforated layer 16, and the second microporous layer 18 may be hot pressed to cause the layers 12, 14, 16,18 to adhere together.

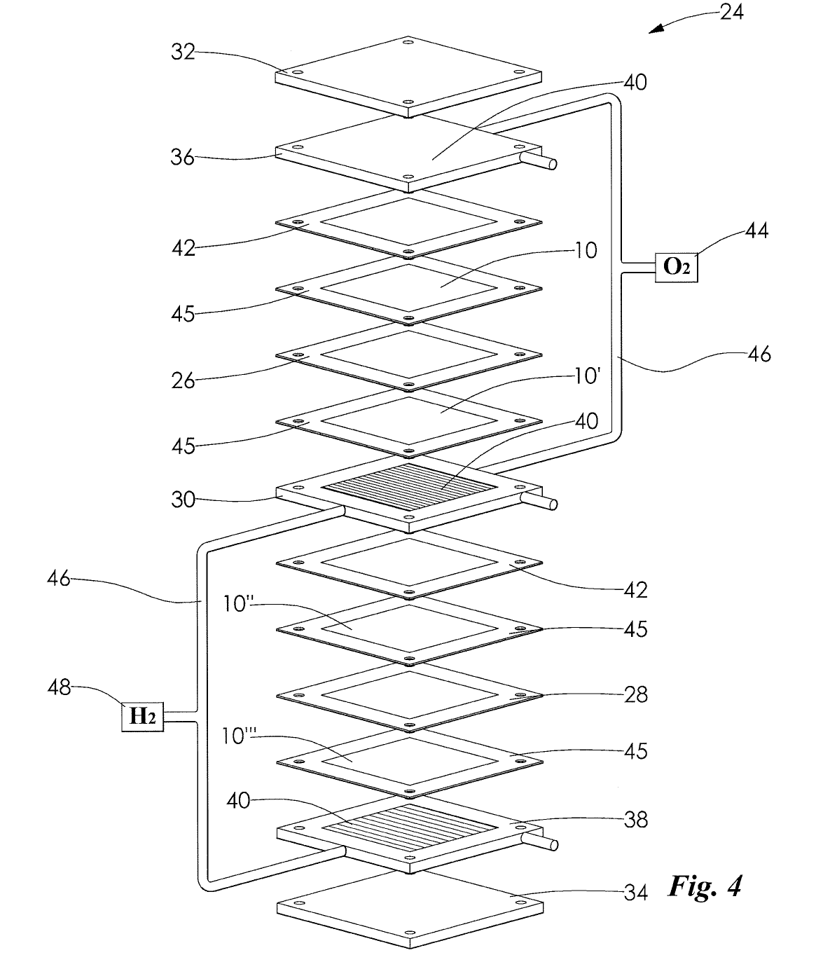

FIG. 4 is an exploded view showing a multi-cell fuel cell stack 24 including two fuel cells. It is understood that the number of fuel cells in the fuel cell stack 24 may vary. As shown, the fuel cell stack 24 has a pair of membrane electrode assemblies (MEA) 26 and 28 separated from each other by an electrically conductive fuel distribution element 30, hereinafter a bipolar plate. The MEAs 26, 28 and bipolar plate 30 are stacked together between stainless steel clamping plates or end plates 32, 34 and end contact elements 36, 38. The end contact element 36 is a cathode, while the end contact element 38 is an anode. The end contact elements 36, 38, as well as both working faces of the bipolar plate 30, contain a plurality of grooves or channels 40 for distributing fuel and oxidant gases (i.e. hydrogen and oxygen) to the MEAs 26, 28. The bipolar plate 30 and end contact elements 36 and 38 may be made from metal but may also be manufactured from other materials, if desired. For example, bipolar plates and end contact elements may be fabricated from graphite which is lightweight, corrosion resistant, and electrically conductive in the environment of a PEM fuel cell stack 24.

In the embodiment shown in FIG. 4, the diffusion media 10, 10′, 10″, 10′″ are adjacent a seal 42. The seal 42 adjacent the diffusion media 10, 10′,10″, 10′″ are gaskets that provide seals and insulation between components of the fuel cell stack 24. A portion of the un-perforated perimeter portion 45 of the thin perforated layers 16 of the diffusion media 10, 10′, 10″,10′″ is disposed immediately adjacent the seals 42 to act as a sub-gasket between the components of the fuel cell stack. The un-perforated portion 45 or sub-gasket may also define an active area of the anode and the cathode such as the sub-gaskets taught in U.S. Pat. No. 6,861,173 for CATALYST LAYER EDGE PROTECTION FOR ENHANCED MEA DURABILITY IN PEM FUEL CELLS, hereby incorporated by reference, for example. The perimeter portion 45 may also provide protection to the edges of the plates 30, 36, 38 and prevents the acidic and potentially corrosive membrane from contacting the plates 30, 36, 38 and seals 42. The un-perforated perimeter portion 45 may also act as a mechanical support for the MEA 26. The diffusion media 10 is disposed between the end contact element 36 and the MEA 26. The diffusion media 10′ is disposed between the MEA 26 and an anode side of the bipolar plate 30 and the diffusion media 10″ is disposed between a cathode side of the bipolar plate 30 and the MEA 28. The diffusion media 10′″ is disposed between the MEA 28 and the end contact element 38.

FIG. 5 shows a cross-sectional view of a portion of a fuel cell of the assembled fuel cell stack 24 of FIG. 4. As shown, the MEA 26 includes a proton exchange membrane 26a sandwiched between an anode catalyst 26b and a cathode catalyst 26c. The MEA 26 is disposed between the end contact element 36 and the anode side of the bipolar plate 30. The diffusion medium 10 is disposed between the end contact element 36 and the MEA 26 with the second side 22 of the porous substrate layer 12 of the diffusion medium 10 disposed adjacent the channels 40 of the end contact element 36. The second microporous layer 18 of the diffusion media 10 is disposed adjacent the cathode catalyst 26c. The diffusion medium 10′ is disposed between the anode side of the bipolar plate 30 and the MEA 26 with the second side 22 of the porous substrate layer 12 of the diffusion medium 10′ adjacent the channels 40 of the bipolar plate 30. The second microporous layer 18 of the diffusion media 10′ is disposed adjacent the anode catalyst 26b.

In use, hydrogen is supplied to the end contact element 38 and the anode side 50 of the bipolar plate 30 of the fuel cell stack 24 from a hydrogen source 48. Oxygen is supplied as the oxidant to the end contact element 36 and the cathode side of the bipolar plate 30 from an oxygen source 44. Alternatively, ambient air may be supplied to the cathode side as an oxidant and hydrogen may be supplied to the anode from a methanol or gasoline reformer.

At the anode side 50, the hydrogen is catalytically split into protons and electrons. The protons formed permeate through the membrane 26a to the cathode side 52. The electrons travel along an external load circuit (not shown) to the cathode side 52 of the MEA 26, thus creating a current output of the fuel cell stack 24. Meanwhile, a stream of oxygen is delivered to the cathode side 52 of the MEA 26. At the cathode side 52, oxygen molecules react with the protons permeating through the membrane 26, and the electrons arriving through the external circuit to form water molecules (not shown). The diffusion media 10, 10′ remove the excess product water during wet operating conditions or at wet regions of the fuel cells of the fuel cell assembly 24 to avoid flooding the electrodes 26c and 26b and also to maintain a degree of hydration of the membrane 26 to obtain decent proton conductivity during dry operating conditions or dry regions of the fuel cells of the fuel cell assembly 24. Excess water in the diffusion media 10, 10′ is removed from the fuel cell stack 24 through manifolds (not shown) by the flow of hydrogen and oxygen gas adjacent to and through diffusion media 10, 10′.

Water management in the fuel cell stack 24 is integral to successful long-term fuel cell stack 24 operation. The diffusion media 10, 10′ aid in water management in the fuel cell stack 24. The diffusion media 10, 10′ have several specific functions. The diffusion media 10, 10′ provide access for the reactant gas from the flow channels 40 to catalyst layers 26b, 26c. Additionally, the diffusion media 10, 10′ are electrically conductive and thermally conductive to provide electron paths and heat removal for the operation of the fuel cell stack 24. Also, the diffusion media 10, 10′ facilitate the removal of product water from the cathode side 52 of the fuel cell stack 24 and then releases the water into the flow channels 40 for removal from the fuel cell stack 24.

For PEM fuel cell stacks 24 adapted for automotive applications, a dryer steady state operating condition is favorable, requiring the diffusion medium 10 to have good water retention capability to maintain a desired hydration of the membrane 26. As diffusion media with high diffusion resistances also reduce reactant mass transport, the diffusion properties of the diffusion medium 10 should be chosen appropriately. In areas of the fuel cell active area with a high local relative humidity and low reactant concentration, such as near the channel outlets of the plates 30, 36, 38, performance may be optimized by using a diffusion medium 10 with low diffusion resistance. In areas of the fuel cell active area with low local relative humidity and high reactant concentration, such as near the gas channel inlets of the plates 30, 36, 38, performance may be optimized by using a diffusion medium 10 with high diffusion resistance. As used herein, the active area is defined as the surface area of an individual fuel cell available for chemical reaction. The size of the active area may vary based on the total area of the fuel cell adapted to accommodate cooling, reactant distribution, and sealing mechanisms.

The present invention provides a means for providing different diffusion properties in the diffusion medium 10 over the fuel cell active area. The different properties are provided by incorporating the thin perforated layer 16 into the diffusion medium 10, and varying the size, spatial frequency, and geometrical pattern of the perforations 43. Varying the size, spatial frequency, and geometrical pattern of the thin perforated layer 16 affects the overall gas diffusion properties through the diffusion medium 10. By reducing the size and frequency of the perforations 43 the porosity (ε) is lowered, while reducing the frequency of the perforations 43 results in a higher tortuosity (τ) of the diffusion medium 10. The ratio between the free diffusion coefficient (D) and effective diffusion coefficient (D_{eff}) through the gas diffusion layer depends on both the porosity and the toruosity of the diffusion medium 10. The relationship is represented as

$$\frac{D}{{D}_{eff}} = \frac{τ}{ɛ} .$$

Accordingly, a reduction in size and spatial frequency of the perforations 43 in the thin perforated layer 16 of the diffusion medium 10 will result in an increase of

$$\frac{D}{{D}_{eff}} .$$

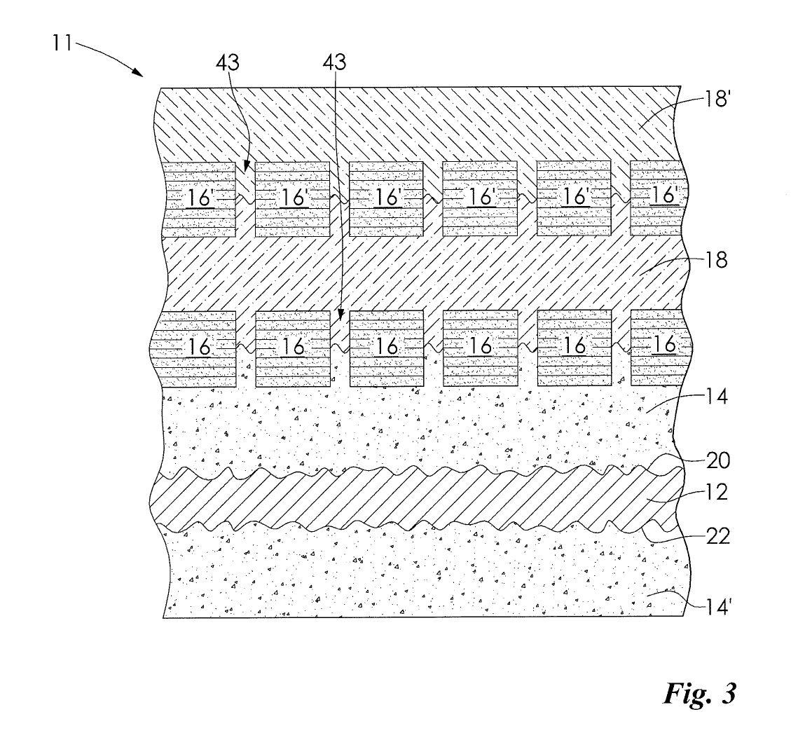

FIG. 3 illustrates a diffusion medium 11 according to another embodiment of the invention. The diffusion medium 11 includes a first porous substrate layer 12, a first microporous layer 14, a first thin perforated layer 16, a second microporous layer 18, a third microporous layer 14′, a second thin perforated layer 16′, and a fourth microporous layer 18′. It is understood that a thickness of the diffusion medium 11 and layers 12, 14, 16, 18, 14′, 16′, 18′ thereof may vary based on the desired performance of a fuel cell in which the diffusion medium 11 is used.

The porous substrate layer 12 is a carbon fiber paper (CFP) having a first side 20 and a second side 22. In the embodiment shown, the porous substrate layer 12 is treated with a polytetrafluoroethylene (PTFE) (not shown). Any traditional CFP such as the MRC U-105 paper produced by Mitsubishi Rayon Company may be used. It is understood that the porous substrate layer 12 may also be a carbon cloth or other conventional material adapted to be electrically and thermally conductive. Furthermore, the porous substrate layer 12 may be untreated or treated with materials other than a fluorocarbon polymer, as desired.

The first microporous layer 14, the second microporous layer 18, the third microporous layer 14′, and the fourth microporous layer 18′ are formed from a carbon powder and fluorocarbon polymer mixture. It is understood that not all of the four microporous layers 14, 14′, 18, 18′ may be desired and the diffusion medium 11 may include any combination of the microporous layers 14, 14′, 18, 18′, as desired.

The thin perforated layers 16, 16′ have a plurality of selectively distributed perforations similar to the perforations 43 of the diffusion medium 10 shown in FIGS. 1 and 2. In the embodiment shown, the thin perforated layers 16, 16′ are graphite foil. However, the thin perforated layers 16, 16′ may be formed from other conventional materials such as metal sheets, polymeric or composite materials, for example. The perforations of the thin perforated layers 16, 16′ may vary to produce variations in local properties. For example, the size and frequency of the perforations 43 in the thin perforated layers 16, 16′ may be varied to provide different gas diffusion resistances. Reducing the frequency of the perforations in the thin perforated layers 16, 16′ results in a higher tortuosity (i.e. effective pore length) of the diffusion medium 11. It is understood that the thin perforated layers 16, 16′ may have similar size and frequency of perforation patterns or the thin perforated layers 16, 16′ may have different size and frequency of perforation patterns, as desired.

To form the diffusion medium 11 the porous substrate layer 12 is treated with the PTFE to form a treated porous substrate layer 12. The thin perforated layers 16, 16′ having desired size and frequency of perforation patterns are formed from a sheet of graphite foil (not shown) by rolling the graphite sheet between rollers (not shown) having protuberant elements adapted to produce perforations in the foil in a desired pattern, shape, and size. A continuous process similar to the one described in U.S. Pat. No. 6,521,369 to Mercuri et al. or a multi-step process may be used to form the thin perforated layers 16, 16′, as desired. The size and placement of the protuberant elements will vary based on the desired pattern, shape, and size of the perforations to obtain the desired gas diffusion resistance.

Next, a paste (not shown) is formed containing a mixture of the carbon powder and fluorocarbon polymers and applied to the first side 20 and the second side 22 of the porous substrate layer 12 to form the first microporous layer 14 and the third microporous layer 14′. While the first and the third microporous layers 14, 14′ are wet, the first thin perforated layer 16 is joined with the porous substrate layer 12 and the first microporous layer 14 such that the first microporous layer 14 is pressed into the perforations 43 of the first thin perforated layer 16 to incorporate the first thin perforated layer 16 with the first microporous layer 14, as shown in FIG. 3. The paste is then applied to an exposed side of the first thin perforated layer 16 to form the second microporous layer 18. While the second microporous layer 18 is wet, the second thin perforated layer 16′ is joined with the second microporous layer 18 and the first thin perforated layer 16 such that the second microporous layer 18 is pressed into the perforations 43 of the second thin perforated layer 16′ to incorporate the second thin perforated layer 16′ with the second microporous layer 18. The carbon powder paste is then applied to an exposed side of the second thin perforated layer 16′ to form the fourth microporous layer 18′. The microporous layers 14, 14′, 18, 18′ are then allowed to dry.

The treated porous substrate layer 12, the first microporous layer 14, the first thin perforated layer 16, the second microporous layer 18, the third microporous layer 14′, the second thin perforated layer 16′, and the fourth microporous layer 18′ are then sintered at or near 380° C. The sintering process causes the microporous layers 14, 14′, 18, 18′, the thin perforated layers 16, 16′, and the porous substrate layer 12 to adhere together.

The diffusion media described above can be used on the cathode side 52 of the fuel cell, the anode side 50 of the fuel cell, or both in order to optimize water management properties of the fuel cell assembly 24. The positioning of the diffusion media 10 described herein will depend on a design of the flow channels 40 and the operating conditions of the fuel cell assembly 24.

The invention has been described above with respect to preferred embodiments. Further non-limiting examples are given in the Examples that follow.

### EXAMPLES

Mitsubishi MRC-U-105 Carbon Fiber Paper, 200 microns thick, is dipped into a PTFE dispersion to achieve an uptake of approximately 10% by weight PTFE. After the paper is dried, a paste formed from an acetylene carbon black and PTFE mixture is coated on one side of the carbon fiber paper to form a microporous layer. The paste is composed of 4.8% solids by weight dispersed in a solution of water and alcohol and the solids are acetylene carbon black and PTFE with a weight ration of 3 to 1. While the microporous layer is wet a perforated expanded graphite foil from Graftech International Ltd. is pressed against the microporous layer and carbon fiber paper. After the microporous layer has dried, another microporous layer is coated on the thin perforated graphite foil. The approximate loading of microporous layer per coating is 1 mg/cm², which results in about 20 microns dry coating thickness. Finally, the carbon paper with microporous layers and a thin perforated layer is sintered by heating at 380° C.

A first sample, diffusion medium A, was prepared with the above method omitting the incorporation of the thin perforated layer. Thus, diffusion medium A has two coatings of paste to achieve approximately the same total microporous loading as the samples containing thin perforated layers. A second sample, diffusion medium B, was prepared according to the above method using a graphite foil from GrafTech International Ltd. having an average thickness of 157 microns, 10,000 perforations per square inch, and perforation sizes such that the thin perforated layer has an average open area of 25%. A third sample diffusion medium C was prepared with a graphite foil from GrafTech International Ltd. having an average thickness of 190 microns, 10,000 perforations per square inch, and perforation sizes such that the thin perforated layer has an average open area of 5%. Thus, nominally the only differences between sample A and samples B and C are the overall diffusion medium thickness and the presence of the thin perforated layer.

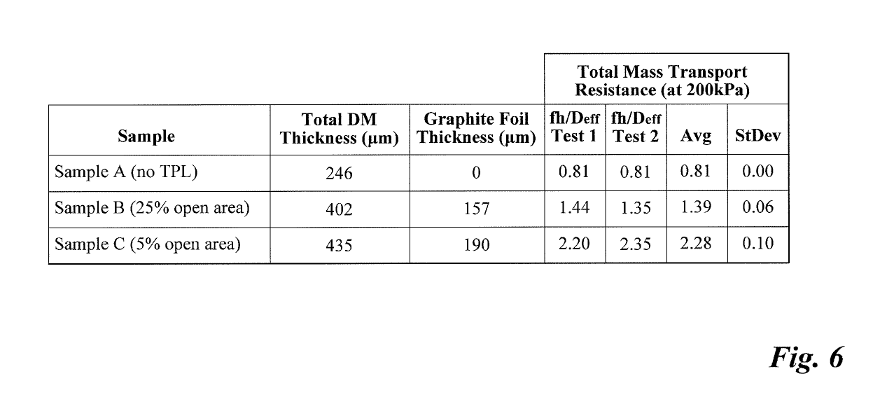

FIG. 6 shows a table of the mass transport resistance values, a measure of diffusion resistance, for the three samples as calculated from limiting current measurements in a 5-cm² active area fuel cell. The limiting current measurement and subsequent effective diffusion coefficient calculation are described in literature by D. Baker, C. Wieser, K. C. Neyerlin, M. W. Murphy, “The Use of Limiting Current to Determine Transport Resistance in PEM Fuel Cells”. ECS Transactions, 3 (1) 989-999 (2006) and by U. Beuscher. “Experimental Method to Determine the Mass Transport Resistance of a Polymer Electrolyte Fuel Cell”. J. Elec. Soc., 153 (9) A1788-A1793 (2006). The values tabulated are the total mass transport resistance,

$$\frac{f \times h}{{D}_{eff}} ,$$

where “f” is a geometrical factor accounting for the fuel cell's channel geometry and “h” is the overall gas diffusion layer's thickness. Mass transport resistance has units of seconds per centimeter (s/cm). The total mass transport resistance is shown at 200 kPa absolute gas pressure. FIG. 6 shows an increase in mass transport resistance from the first sample A to the second sample B to the third sample C. Accordingly, the gas transport resistance of the samples B, C increased with decreasing perforation area.

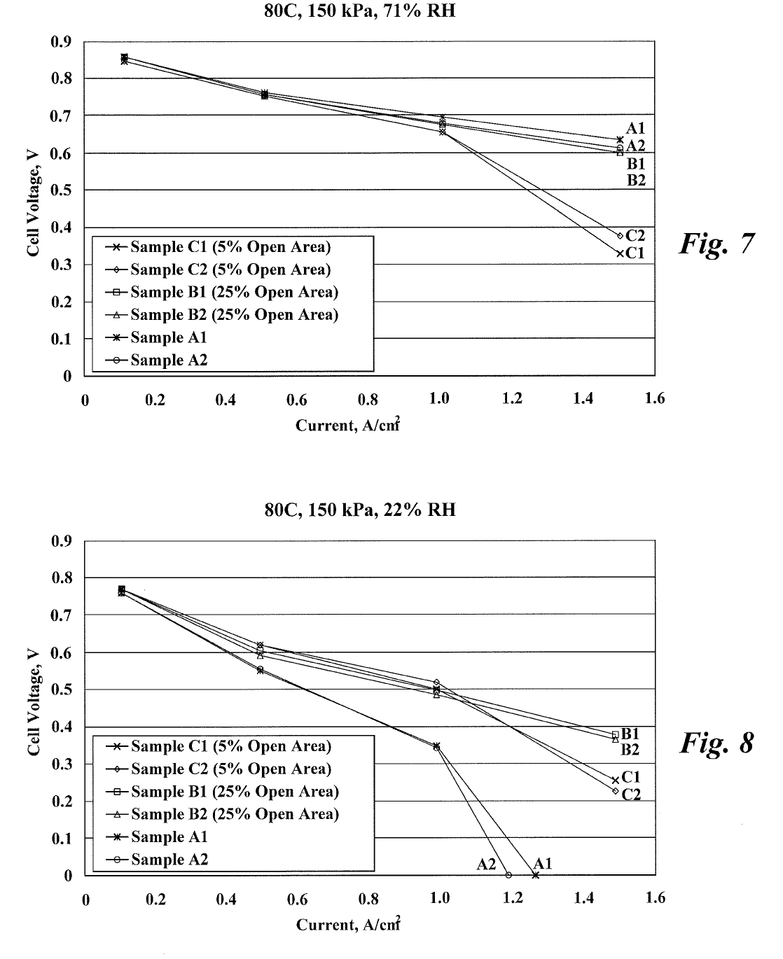

The diffusion media samples A, B, C were tested in fuel cells under different operating conditions. FIGS. 7 and 8 show the results in terms of current versus voltage curves for samples A, B, and C. A repeat test was performed on each sample A, B, C to produce six curves A1, A2, B1, B2, C1, C2. The samples were assembled as the cathode diffusion media in a fuel cell with a Gore 5510 membrane electrode assembly. Johnson Matthey diffusion media was used on the anode side. The fuel cell included straight channels with a 5 cm² active area. The fuel cell was operated under high anode and high cathode stoichiometries, mostly greater than 10 except for four high current density setpoints where the stoichiometry was between 3 and 6. The test performed on the samples A, B, C under the above operating conditions is known as a differential cell test. Under the differential cell test, it can be assumed that the operating conditions, including the reactant concentrations and relative humidity, are constant along the channel in the measurement area.

FIG. 7 shows the current versus voltage curves for the samples A, B, C performed at 80° C., 150 kPa absolute, and 71% relative humidity. The curves for the second sample B1, B2 and third sample C1, C2 show no appreciable performance difference compared to the curves for the first sample A1, A2 at relatively low currents (1.0 A/cm² and below), while the voltages for the third sample C1, C2 show a significant decrease at high current densities (1.5 A/cm²). The first sample A1, A2 and the second sample B1, B2 have been shown to be the diffusion medium having stable water management capability under this operating condition.

FIG. 8 shows the current versus voltage curves for the samples A, B, C performed at 80° C., 150 kPa, and 22% relative humidity. Under these relatively dry conditions, the curves have a distinct spread. The curves for the third sample C1, C2 show a performance improvement of the fuel cell compared to the first sample A1, A2. The curves for the second sample B1, B2 show an even greater performance improvement of the fuel cell compared to the first sample A1, A2. The second sample B1, B2 and the third sample C1, C2 with the perforated thin foil have shown superior water management capability compared to the first sample A1, A2 under relatively dry conditions.

Accordingly, the benefit of different gas diffusion media samples A, B, C at relatively humid and dry operating conditions has been illustrated in the above examples. The incorporation of a thin perforated layer 16 into the porous substrate layer 12 has been shown to increase the diffusion resistance and water management capabilities within the fuel cell stack depending on the specific perforation features of the thin perforated layer 16.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A diffusion medium for use in a PEM fuel cell comprising:
a porous substrate layer having a first side and a second side,
wherein said porous substrate layer is electrically conductive;
a first microporous layer; and
a thin perforated layer having a plurality of perforations, a first side, and a second side, wherein said first microporous layer is disposed between and incorporated into the first side of said porous substrate layer and the first side of said thin perforated layer.

2. The diffusion medium of claim 1, further comprising a second microporous layer disposed on and incorporated into the second side of said thin perforated layer.

3. The diffusion medium of claim 1, wherein said porous substrate layer is a carbon fiber paper.

4. The diffusion medium of claim 1, wherein said thin perforated layer is an expanded graphite foil.

5. The diffusion medium of claim 2, wherein said first microporous layer and said second microporous layer are one of a carbon powder, a fluorocarbon polymer, and a carbon powder and a fluorocarbon polymer mixture.

6. The diffusion medium of claim 5, wherein the fluorocarbon polymer is polytetrafluoroethylene.

7. The diffusion medium of claim 1, wherein said thin perforated layer has a varying size and frequency of perforation patterns over an active area of the diffusion medium to facilitate varied water management capabilities.

8. The diffusion medium of claim 1, wherein the varied size and frequency of perforation patterns may be prepared on a single thin perforated sheet or by combining multiple perforated sheets, each of the multiple perforated sheets having a uniform size and frequency of perforation pattern.

9. The diffusion medium of claim 1, wherein said thin perforated layer includes an un-perforated perimeter adapted to form a sub-gasket between components of the fuel cell.

10. The diffusion medium of claim 1, wherein said first microporous layer, said porous substrate layer, and said thin perforated layer are sintered together.

11. A diffusion medium for use in a PEM fuel cell comprising:
a porous substrate layer having a first side and a second side,
wherein said substrate layer is electrically conductive;
a thin perforated layer having a plurality of perforations;
a first microporous layer, wherein said first microporous layer is disposed between the first side of said porous substrate layer and said thin perforated layer, said first microporous layer incorporated into the first side of said porous substrate layer, and the thin perforated layer is incorporated into said first microporous layer; and
a second microporous layer disposed on and incorporated with said thin perforated layer.

12. The diffusion medium of claim 11, wherein said first microporous layer and said second microporous layer are one of a carbon powder, a fluorocarbon polymer, and a carbon powder and a fluorocarbon polymer mixture.

13. The diffusion medium of claim 12, wherein the fluorocarbon polymer is polytetrafluoroethylene.

14. The diffusion medium of claim 11, wherein said thin perforated layer has a varying size and frequency of perforation patterns over an active area of the diffusion medium to facilitate varied water management capabilities.

15. The diffusion medium of claim 11, wherein the varied size and frequency of perforation patterns may be prepared on a single thin perforated sheet or by combining multiple perforated sheets, each of the multiple perforated sheets having a uniform size and frequency of perforation pattern.

16. The diffusion medium of claim 11, wherein said thin perforated layer includes an un-perforated perimeter adapted to form a sub-gasket between components of the fuel cell.

17. The diffusion medium of claim 11, wherein said first microporous layer, said porous substrate layer, and said thin perforated layer are sintered together.

18. A method for making a diffusion medium for use in a PEM fuel cell, comprising the steps of:
providing a porous substrate layer, wherein said porous substrate layer is electrically conductive;
providing a thin perforated layer with one of a variable size and frequency of perforation pattern;
treating the porous substrate layer with a fluoropolymer;
coating the flouropolymer treated porous substrate layer with a paste to form a microporous layer;
compressing the thin perforated layer onto the wet microporous layer;
drying the microporous layer and the porous substrate layer; and
sintering the porous substrate layer, thin perforated layer, and the microporous layer together.

19. The method of claim 18, further comprising the step of forming the thin perforated layer with a roller having protrusions in a desired pattern to obtain the desired size and frequency of perforation pattern.

20. The method of claim 18, further comprising the step of providing a plurality of the thin perforated layers disposed adjacent one another on the microporous layer to obtain the desired variable gas diffusion resistance.
